(19) United States
(12) Patent Application Publication
(10) Pub. No.: US 2013/0299035 A1
(43) Pub. Date: Nov. 14, 2013

(54) Thermal Textile Sleeve Having An Outer Robust Metallic Layer And Method Of Enhancing The Robustness Of A Thermal Sleeve Therewith

(71) Applicant: Federal-Mogul Powertrain, Inc., Southfield, MI (US)

(72) Inventors: Benoit Laurent, Trosly Breuil (FR); Harry F. Gladfelter, Kimberton, PA (US); Jimmy Teal, Mohton, PA (US); Cassie M. Malloy, Bluebell, PA (US); Zhong Huai Zhang, Pottstown, PA (US)

(21) Appl. No.: 13/839,348

(22) Filed: Mar. 15, 2013

Related U.S. Application Data
(60) Provisional application No. 61/646,639, filed on May 14, 2012.

(51) Int. Cl. F16L 59/02; B23P 19/00

(52) U.S. Cl. CPC F16L 59/028; B23P 19/00; F16L 59/029
USPC 138/147; 29/428

(57) ABSTRACT

A tubular thermal sleeve assembly for providing protection to an elongate member and method of enhancing the robustness of a thermal sleeve with the assembly is provided. The thermal sleeve assembly includes a tubular wall of insulative material having an outer surface and an inner surface bounding a cavity extending along a longitudinal central axis for receipt of the elongate member. The assembly further includes a flexible outer layer of metallic material extending along the longitudinal central axis between opposite ends with the metallic material having a plurality of openings formed between the opposite ends.

### CROSS-REFERENCE TO RELATED APPLICATION

This application claims the benefit of U.S. Provisional Application Ser. No. 61/646,639, filed May 14, 2012, which is incorporated herein by reference in its entirety.

### BACKGROUND OF THE INVENTION

1. Technical Field

This invention relates generally to sleeves for protecting elongate members and more particularly to tubular, high temperature textile sleeves.

2. Related Art

Tubular knit sleeves are known for use to protect and provide a barrier to heat radiation from tubing contained within the sleeves. The sleeves are commonly constructed from heat resistant or fire retardant yarn to withstand relatively high temperatures. Sometimes the sleeves are used to insulate high temperature tubes, such as those providing a conduit for hot gas or liquid, to inhibit the heat from radiating beyond the confines of the tubing, such as an exhaust pipe. Although the knit sleeves are generally effective in performing their insulating function, they are commonly viewed as being less than tough, hardy, rugged and durable, given their interlaced textile construction. This is particularly true in the heavy duty truck market, where the owners typically take pride in the outer rough ‘truck appearance’.

In addition to the textile sleeve discussed above, it is known to wrap and laminate a sheet of foil about the textile sleeves to provide them with an ability to reflect radiant heat. This is typically done in regions of the tube wherein it is desirable to reduce the temperature of the gas flowing within the tube. However, the presence of the laminated foil layer reduces the flexibility and conformability of the sleeve, which can make routing the sleeve about bends difficult or impossible without causing the foil layer to tear or become otherwise unsightly.

### SUMMARY OF THE INVENTION

A tubular thermal sleeve assembly for providing protection to an elongate member is provided. The thermal sleeve assembly includes a tubular wall of insulative material having an outer surface and an inner surface bounding a cavity extending along a longitudinal central axis for receipt of the elongate member. The assembly further includes a flexible outer layer of metallic material extending along the longitudinal central axis between opposite ends with the metallic material having a plurality of openings formed between the opposite ends.

In accordance with another aspect of the invention, the tubular thermal sleeve assembly further includes a latch configured to move from an unlatched position to a latched position to effectively reduce the inner diameter of the metallic material to bring the metallic material beneath the latch into a snug fit with the tubular wall.

In accordance with another aspect of the invention, the metallic material has opposite edges extending generally parallel to the longitudinal central axis, wherein the opposite edges are configured for releasably fixed, overlapping relation with one another.

In accordance with another aspect of the invention, the latch is configured to releasably fix the opposite edges in overlapping relation with one another.

In accordance with another aspect of the invention, the latch has a pair of hooks configured for attachment within the openings adjacent separate edges. The latch has a lever operable to move the hooks toward one another to a latched position to reduce an inner diameter of the metallic material to maintain the opposite edges in fixed overlapping relation and to allow the hooks to move away from one another to an unlatched position to allow the pair of hooks to be removed from the openings, whereupon the metallic material can be removed.

In accordance with another aspect of the invention, the metallic material and the latch are stainless steel.

In accordance with another aspect of the invention, the metallic material has a plurality of metal loops interlinked with one another.

In accordance with another aspect of the invention, the metallic material is a flat, perforated metallic cloth.

In accordance with another aspect of the invention, the metallic material is radially and longitudinally expandable.

In accordance with another aspect of the invention, a method of enhancing the robustness of a thermal sleeve disposed about an elongate tubular member received therein is provided. The method includes disposing a flexible layer of metallic material having a plurality of openings about an outer surface of the thermal sleeve, and bringing at least a portion of the flexible layer of metallic material into a snug fit about the thermal sleeve by applying a fastener to at least a portion of the flexible layer of metallic material.

In accordance with another aspect of the invention, the method further includes wrapping opposite edges of the flexible layer of metallic material about an outer surface of the thermal sleeve and bringing opposite edges into overlapping relation with one another. Then, releasably fixing the opposite edges in overlapping relation with one another.

In accordance with another aspect of the invention, the method further includes fixing the opposite edges in overlapping relation with one another with a latch moveable between a latched position and unlatched position.

In accordance with another aspect of the invention, the method further includes providing the latch having a plurality of hooks and disposing the hooks in openings adjacent opposite lengthwise extending edges of the metallic material and moving the latch from the unlatched position to the latched position causing the hooks to move toward one another thereby reducing an inner diameter of the metallic material and bringing the metallic material into a snug fit about the thermal sleeve.

In accordance with another aspect of the invention, the method further includes providing the metallic material as one of a plurality of interlinked metal loops or a perforated metal cloth.

In accordance with another aspect of the invention, the method further includes providing the latch and metallic material as stainless steel.

In accordance with a further aspect of the invention, the metallic material can be provided having a circumferentially continuous, seamless wall.

In accordance with another aspect of the invention, the method further includes providing the metallic material being radially and longitudinally expandable.

### BRIEF DESCRIPTION OF THE DRAWINGS

These and other objects, features and advantages will become readily apparent to those skilled in the art in view of the following detailed description of the presently preferred embodiments and best mode, appended claims, and accompanying drawings, in which:

FIG. 1 is a perspective view of a thermal tubular sleeve assembly in accordance with one aspect of the invention including a thermal sleeve disposed about an elongate tubular member with an outer metallic layer wrapped thereabout;

FIG. 2 is an end view of the thermal tubular sleeve assembly of FIG. 1 with a latch shown in an unlatched position;

FIG. 2A is an end view of a thermal tubular sleeve assembly in accordance with another aspect of the invention including a thermal sleeve disposed about an elongate tubular member with an outer metallic layer disposed thereabout with a latch shown in an unlatched position;

FIG. 3 is an end view of the thermal tubular sleeve assembly of FIG. 1 with the latch shown in a latched position;

FIG. 3A is an end view of the thermal tubular sleeve assembly of FIG. 2A with the latch shown in a latched position;

FIG. 4 is a perspective view of the latch shown in an unlatched position;

FIG. 5 is a plan view of the metallic material constructed in accordance with one aspect of the invention; and

FIG. 6 is a plan view of the metallic material constructed in accordance with another aspect of the invention.

### DETAILED DESCRIPTION OF PREFERRED EMBODIMENTS

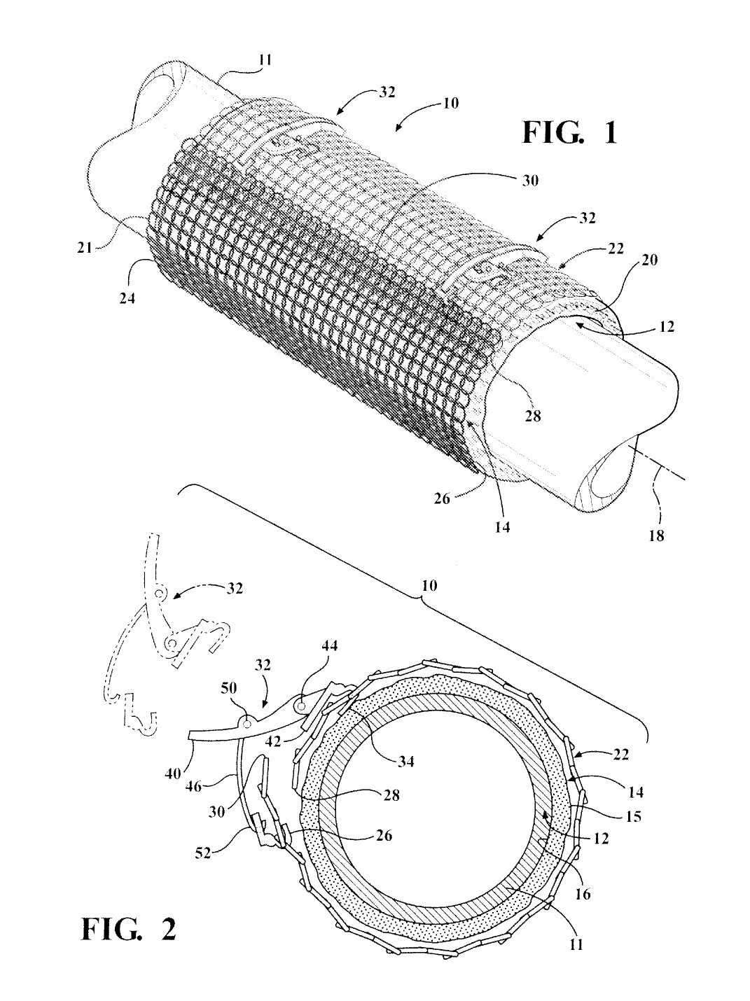

Referring in more detail to the drawings, FIG. 1 shows a thermal textile tubular sleeve assembly, referred to hereafter as assembly 10, constructed according to one presently preferred embodiment of the invention. The assembly 10 provides thermal protection to an elongate member, such as a tubular member, and in particular, an exhaust pipe 11, received within an enclosed tubular cavity 12 of the assembly 10. The assembly 10 has a plurality of yarns knitted into a seamless tubular wall 14 having an outer surface 15 and an inner surface 16 defining the cavity 12 extending axially along a longitudinal central axis 18 between opposite ends 20, 21 of the wall 14. The outer and inner surfaces 15, 16 of the wall 14 can be expanded radially outwardly from the longitudinal axis 18 and longitudinally along the longitudinal axis 18 due to knit loops of yarn being radially expandable and axially extendible, thereby allowing the wall 14 to conform and bend about the pipe 11, as desired. The sleeve 10 has a separate metallic material, also referred to as metallic outer layer or outer layer 22, surrounding the wall 14 to perform multiple functions. Generally, the outer layer 22 enhances the robustness and rugged appearance of the wall 14, which is desirable in applications such as heavy-duty trucks, for example. Further, the outer layer 22 enhances the abrasion resistance of the wall 14; enhances the ability of the wall 14 to withstand extreme temperatures without losing its original appearance and flexibility; enhances the ability of the wall 14 to reflect radiant heat from nearby sources of extreme heat, e.g. exhaust manifold, exhaust pipes, engine block; enhances the fluid resistance of the wall 14 by providing an additional barrier to fluids, and maintains the ability of the wall 14 to remain flexible, conformable and radially expandable.

The knit wall 14, in one presently preferred construction, can be constructed at least in part from a heat resistant material(s) suitable for withstanding high temperature environments ranging from between about −60 to 1400 degrees centigrade. Some of the selected yarns could be formed with silica, fiberglass, ceramic, basalt, aramid or carbon, by way of example and without limitations. In some applications of extreme heat, it may be desirable to heat treat the sleeve material to remove organic content therefrom, thereby increasing the heat resistance capacity of the assembly 10. It should be recognized that the wall 14 could be constructed utilizing any type of material(s) suitable for knitting a tubular sleeve, such as polyester, nylon, polypropylene, polyethylene, acrylic, cotton, rayon, and fire retardant (FR) versions of all the aforementioned materials, as desired for the intended application. The wall 14 can be knit having any suitable length, and further, can be knit to facilitate reverse folding at least a portion of the wall to form a dual layer wall, if desired. It should be recognized that the type and size of the knit stitches used to form the wall 14 can be varied along the wall to provide different axially extending regions with different knit properties. Further, it should be recognized that the wall 14 can be knit using different types of yarn for different axially extending regions. As such, if reverse folded, the inner and outer layers can have different knit stitches, densities and types of yarn, as desired.

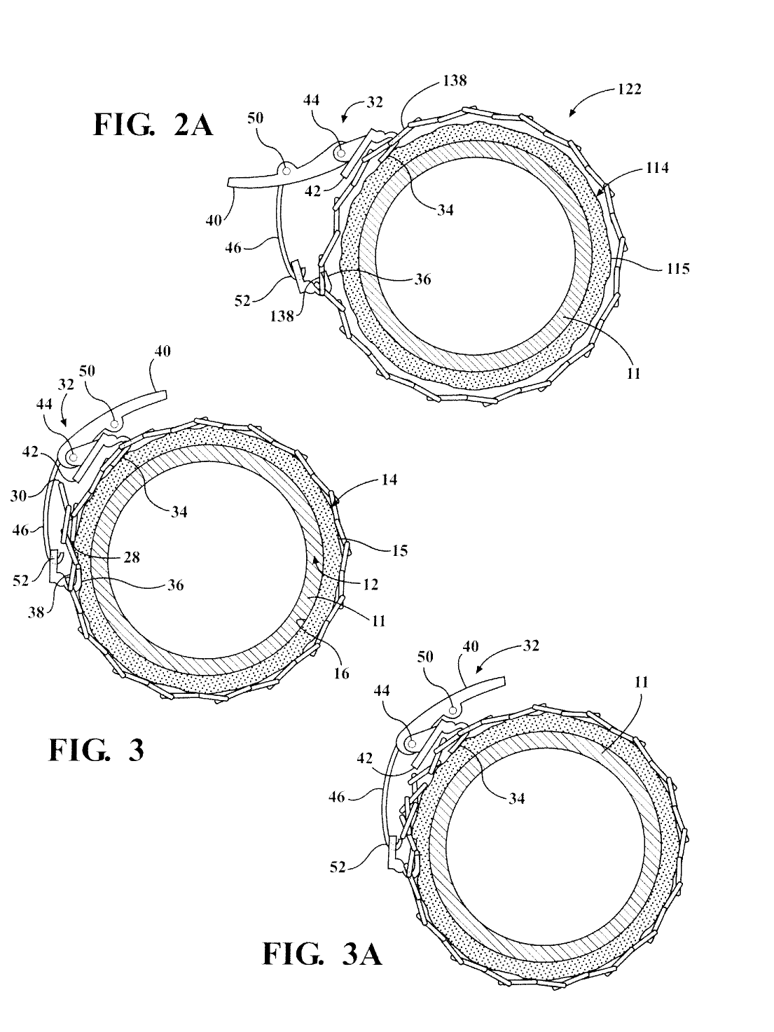

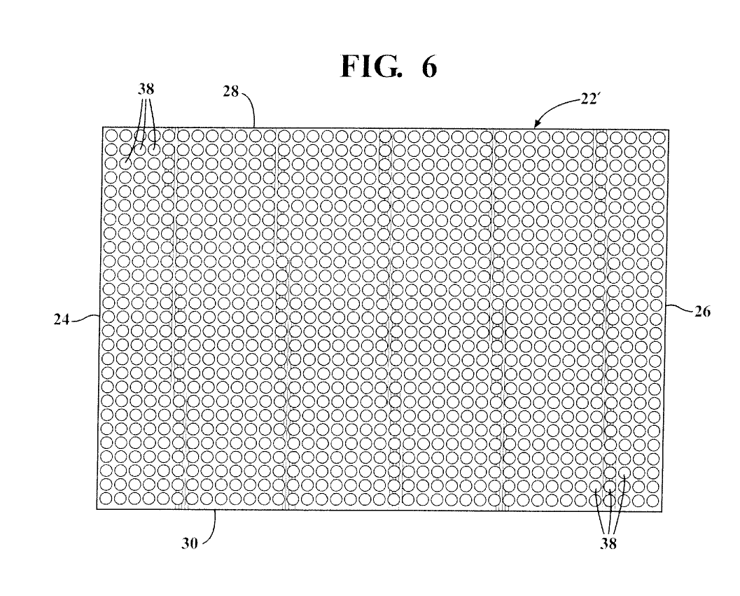

The outer layer 22 can be constructed of various drapable metallic materials, and is preferably constructed from stainless steel, e.g. 304 or 316 stainless steel, though other materials are contemplated, e.g. galvanized steel, anneal steel, copper, or otherwise, depending on the application requirements. The metallic material can be formed as a drapable chainmail layer (ring mesh formed of a plurality of interlinked loops of metal wire material; FIG. 5) or a drapable perforated metallic cloth layer or a flat mesh of wire material 22′; FIG. 6). The outer layer 22, upon being formed having the desired length L extending between opposite ends 24, 26 and desired width W extending between opposite side edges 28, 30 to allow the outer layer 22 to drape along the length of the wall 14 desired and about the entire circumference of the wall 14, with the opposite side edges 28, 30 overlapping one another, while allowing for the desired amount of radial expansion. Then, with the outer layer 22 wrapped about the entire circumference of the wall 14, the outer layer 22 is releasably fixed about the wall 14 via any suitable mechanical fastening mechanism, e.g. tied, stitched, riveted, snapped, or otherwise, and preferably a latch 32. Otherwise, if the metallic outer layer 122 is formed as a seamless, circumferentially continuous tube, as shown in FIG. 2A, in accordance with another aspect of the invention, wherein the same reference numerals are used, offset by a factor of 100, to identify like features, the outer layer 122 is slid axially over the wall 114 and fixed about the wall 114 via any suitable mechanical fastening mechanism, and particularly the 32 latch. In the seamless outer layer 122 embodiment, the fastener, e.g. latch 32, gathers the material of the outer layer 122 grasped by the latch 32 circumferentially, thereby reducing the effective inner diameter in the circumferential region of the latch 32, and thus, bringing at least a portion of the outer layer 122 into a snug fit about the outer surface 115 of the thermally insulative tubular wall 114. It should be recognized that the vast majority of the outer layer 122 retains its full, unrestricted ability to expand radially and stretch axially, as most the outer layer 122 is not confined by the fastener or latch 32

With the outer layer 22 being releasably fixed and wrapped about the wall 14, the outer layer 22 can be easily positioned in the desired location along the length of pipe 11 with the tubular wall 14 already installed on the elongate member 11. However, if the metallic outer layer 122 is tubular, the metallic outer layer 122 can be readily slid over the pipe 11 and the wall 114 while in its radially expanded state, and then, the fastener 32 can be applied to circumferentially constrict at least a portion of the metallic outer layer 122 into a snug fit about the wall 114. Being that the wall 14, 114 and outer layer 22, 122 are both radially expandable, as well as being axially extendible and highly flexible, positioning and fixation of the assembly 10 about the pipe 11 is made easy. Further, during use and upon being exposed to extreme thermal conditions, e.g. −60 to 1400 degrees centigrade, the wall 14, 114 and outer layer 22, 122 retain their original physical properties and appearance, thereby maintaining their ability to function as intended, while also retaining their attractive physical appearance. With the outer layer 22, 122 being constructed of durable metal, the underlying knit sleeve wall 14, 114 is protected against abrasion and impact damage, such as may be encountered from road debris. Further, the metallic material of the outer layer 22, 122 reflects radiant heat from adjacent engine components, thereby allowing the exhaust gas within the pipe 11 to cool, as desired.

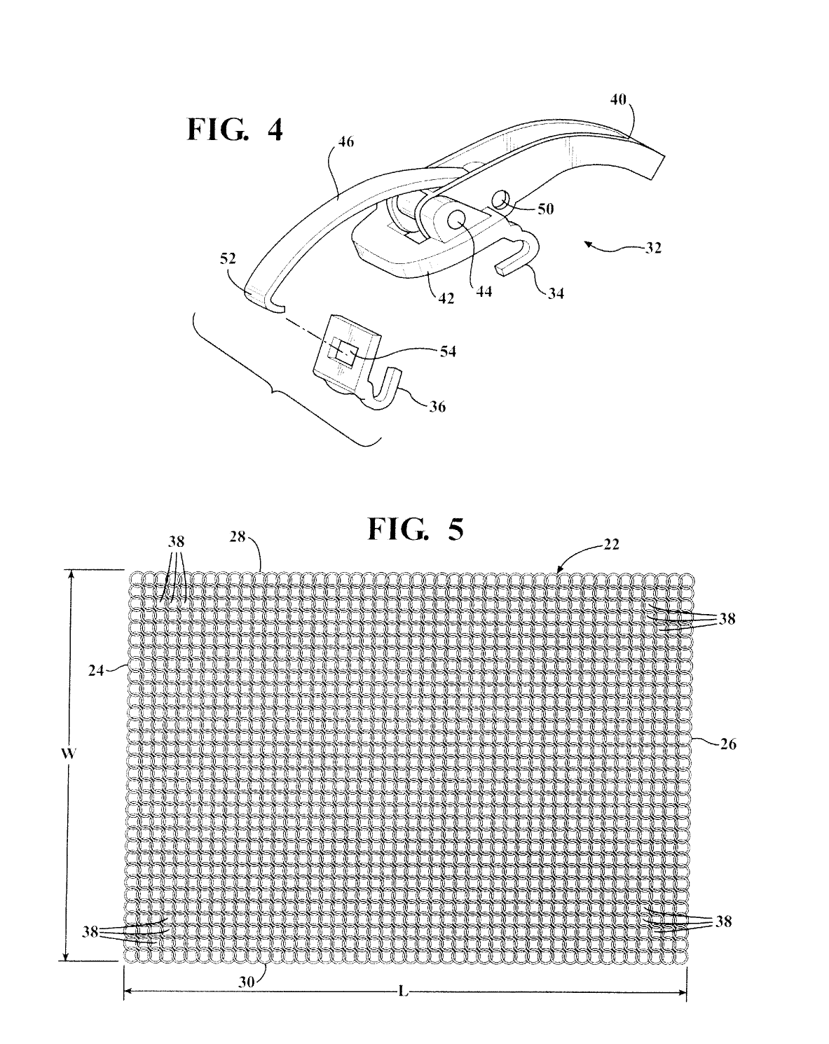

As best shown in FIG. 4, the latch 32 (discussion hereafter applies equally to the latch 32, as they are identical) has a plurality of hooks, shown as a pair of hooks 34, 36, configured for attachment within openings 38, 138 formed within the metallic outer layer 22, 122 between the opposite ends 24, 26 and between the opposite edges 28, 30. The latch 32 includes a lever 40 that is pivotal and operable to move the hooks 34, 36 toward one another to a latched position (FIGS. 3, 3A) to reduce an inner diameter of the flexible outer layer 22, 122, at least immediately beneath the latch 32, to maintain the flexible outer layer 22, 122 in releasably fixed relation about the tubular wall 14, 144 of insulative material. It should be recognized that the majority of the flexible outer layer 22, 122 spaced axially from the latch 32 retains an ability to expand radially and stretch axially, as these regions are not stretched circumferentially by the latch 32. The latch 32 has a body 42 with a first one of the pair of hooks, or first hook 34, fixed thereto, shown as being formed as a monolithic piece of material with one another, by way of example, with the lever 40 being pivotally coupled to the body 42 at a pin joint 44 for selective movement of the lever 40 over-center between the latched and unlatched positions. The other of the hooks, also referred to as second one of the pair of hooks, or second hook 36, is operably coupled to the lever 40 via a strap 46. One end of the strap 46 is attached to another pin joint 50 on the handle 40 that is located closer the free end of the handle than the other pin joint 44, establishing the over-center construction of the latch 32, while an opposite end 52 of the strap 46 is configured for releasable attachment to the second hook 36. The end 52 is shown having an arcuate or curled configuration for receipt within an opening 54 of the second hook 54. It should be recognized that when the end 52 is received within the opening 54 of the second hook 54 and the latch 32 is in its latched position, that the curled end 52 is maintained in grasping relation with the second hook 36 such that the two are inseparable. However, when the latch 32 is selectively moved to its unlatched position, the curled end 52 can be removed from the opening 54 of the second hook 36, thereby allowing the strap 46 to be lifted away from the second hook 36 for easy removal of the latch 32 from the metallic outer layer 22, 122, thereby allowing disassembly of the metallic outer layer 22, 122 from the wall 14, 114, as desired. By having the second hook 36 detachable from the strap 46, the second hook 36 can be readily located within the desired opening 38 of the outer layer 22, 122 and then the end 52 of the strap can be disposed in the opening 54 of the second hook 54. If the second hook 36 were not a separable from the latch 32, it would be increasingly difficult to locate the second hood 54 in the optimal opening 38 to achieve the desire clamping about the metallic outer layer 22, 122.

In accordance with a further aspect of the invention, a method of enhancing the robustness of a thermal sleeve disposed about an elongate tubular member received therein is provided. The method includes disposing a flexible outer layer of metallic material 22, 122, as described above, having a plurality of openings 38 about an outer surface 15 of a thermal sleeve 14. Then, bringing at least a portion of the flexible outer layer 22, 122 into a snug or relatively snug fit about the thermal sleeve 14 by applying a fastener 40 to at least a portion of the flexible outer layer 22, 122.

The method can further include providing the fastener 40 as a latch having a plurality of hooks 34, 36 and a lever 40 operable to move the hooks 34, 36 toward one another to a latched position, and inserting the hooks 34, 36 into selected openings 38 and moving the lever 40 to draw the hooks 34, 36 toward one another to the latched position.

The method can further include providing the flexible outer layer 22 having opposite edges 28, 30 extending generally parallel to one another and wrapping the flexible outer layer 22 about the thermal sleeve 14 and bringing the opposite edges 28, 30 into releasably fixed overlapping relation with one another.

It should be recognized that thermal sleeve assemblies 10, 110 constructed in accordance with the invention are suitable for use in a variety of applications, regardless of the sizes and lengths required. For example, they could be used in automotive, marine, industrial, aeronautical or aerospace applications, or any other application wherein protective sleeves are desired to protect elongate members, such as, from abrasion or high temperatures.

It is to be understood that the above detailed description is with regard to some presently preferred embodiments, and that other embodiments which accomplish the same function are incorporated herein within the scope of any ultimately allowed patent claims.

What is claimed is:

1. A tubular thermal sleeve assembly for providing protection to an elongate member, comprising:
a tubular wall of insulative material having an outer surface and an inner surface bounding a cavity extending along a longitudinal central axis for receipt of the elongate member; and
a flexible outer layer of metallic material extending along said longitudinal central axis between opposite ends with a plurality of openings extending between said opposite ends.

2. The tubular thermal sleeve assembly of claim 1 further including a latch configured to move from an unlatched position to a latched position to releasably fix said flexible outer layer about said tubular wall of insulative material.

3. The tubular thermal sleeve assembly of claim 2 wherein said latch has a plurality of hooks configured for attachment within said openings, said latch further including a lever operable to move said hooks toward one another to a latched position to reduce an inner diameter of said flexible outer layer to maintain said flexible outer layer about said tubular wall of insulative material.

4. The tubular thermal sleeve assembly of claim 3 wherein said latch has a body with a first one of said pair of hooks fixed thereto with said lever being pivotally coupled to said body.

5. The tubular thermal sleeve assembly of claim 4 where said lever is operably attached to a second one of said pair of hooks by a strap.

6. The tubular thermal sleeve assembly of claim 5 wherein said strap is detachable from said second one of said pair of hooks while in said unlatched position.

7. The tubular thermal sleeve assembly of claim 2 wherein said flexible outer layer and said latch are stainless steel.

8. The tubular thermal sleeve assembly of claim 1 wherein said flexible outer layer has a plurality of metal loops interlinked with one another.

9. The tubular thermal sleeve assembly of claim 8 wherein said flexible outer layer is flexible, radially and longitudinally expandable and contractible such that it can readily expand or contract with said tubular wall.

10. The tubular thermal sleeve assembly of claim 1 wherein said flexible outer layer is a flat, perforated metallic cloth.

11. The tubular thermal sleeve assembly of claim 1 wherein said flexible outer layer has opposite edges extending generally parallel to said longitudinal central axis with said opposite edges being configured to overlap one another.

12. The tubular thermal sleeve assembly of claim 11 further including a latch configured to move from an unlatched position to a latched position to releasably fix said opposite edges in overlapping relation with one another.

13. The tubular thermal sleeve assembly of claim 12 wherein said latch has a plurality of hooks configured for attachment within said openings adjacent separate ones of said opposite edges, said latch further including a lever operable to move said hooks toward one another to said latched position to reduce an inner diameter of said flexible outer layer to maintain said opposite edges in fixed overlapping relation with one another.

14. The tubular thermal sleeve assembly of claim 1 wherein said wall is knit.

15. The tubular sleeve assembly of claim 14 wherein said wall is formed from yarn capable of withstanding temperatures between about −60 to 1400 degrees centigrade.

16. A method of enhancing the robustness of a thermal sleeve disposed about an elongate tubular member received therein, comprising the steps of:
disposing a flexible outer layer of metallic material having a plurality of openings about an outer surface of the thermal sleeve; and
bringing at least a portion of the flexible outer layer into a snug fit about the thermal sleeve by applying a fastener to at least a portion of the flexible outer layer.

17. The method of claim 16 further including providing a latch having a plurality of hooks and a lever operable to move the hooks toward one another to a latched position, and inserting the hooks into selected openings and moving the lever to draw the hooks toward one another to the latched position.

18. The method of claim 17 further including providing the flexible outer layer having opposite edges extending generally parallel to one another and wrapping the flexible outer layer about the thermal sleeve and bringing the opposite edges into overlapping relation with one another.

19. The method of claim 16 further including providing the flexible outer layer having opposite edges extending generally parallel to one another and wrapping the flexible outer layer about the thermal sleeve and bringing the opposite edges into releasably fixed overlapping relation with one another.

20. The method of claim 19 further including providing a latch having a plurality of hooks and disposing the hooks in openings adjacent the opposite edges of the flexible outer layer and moving the latch from the unlatched position to a latched position causing the hooks to move toward one another thereby reducing an inner diameter of the flexible outer layer and bringing at least the reduced diameter portion of the flexible outer layer into a snug fit about the thermal sleeve.

21. The method of claim 20 further including providing the latch as stainless steel.

22. The method of claim 16 further including providing the flexible outer layer as one of a plurality of interlinked metal loops or a perforated metal cloth.

23. The method of claim 22 further including providing the flexible outer layer as stainless steel.

24. The method of claim 16 further including providing the flexible outer layer as being radially and axially expandable.
